(19) United States
(12) Patent Application Publication
(10) Pub. No.: US 2019/0050772 A1
(43) Pub. Date: Feb. 14, 2019

(54) SCHEDULE ARBITRATION SYSTEM

(71) Applicant: HITACHI, LTD., Tokyo (JP)

(72) Inventors: Tomoichi EBATA, Tokyo (JP); Tatsuhiro SATOU, Tokyo (JP); Yumiko ISHIDO, Tokyo (JP)

(73) Assignee: HITACHI, LTD., Tokyo (JP)

(21) Appl. No.: 15/759,092

(22) PCT Filed: Jan. 29, 2016
(86) PCT No.: PCT/JP2016/052562

§ 371 Date: Mar. 9, 2018

(51) Int. Cl. G06Q 10/06; B61L 27/00; G06Q 10/08

(52) U.S. Cl. CPC G06Q 10/06315; G06Q 10/087; G06Q 10/083; B61L 27/0016

(57) ABSTRACT

A schedule arbitration server is configured to obtain a first scheduling constraint and first schedule information from a first server, and obtain a second scheduling constraint and second schedule information from a second server; detect a discrepancy between the first schedule information and the second schedule information, based on the first scheduling constraint, the first schedule information, the second scheduling constraint, and the second schedule information, and on overall optimization constraint information; recreate a schedule when a discrepancy is detected, by creating third and fourth schedule information through modification of the first schedule information and the second schedule information; calculate a first credit for the first server and a second credit for the second server, based on degrees of modification; and send the third schedule information and the first credit to the first server, and send the fourth schedule information and the second credit to the second server.

### BACKGROUND

This invention relates to a schedule arbitration system configured to arbitrate schedules among a plurality of systems.

With the globalization of production, the number of occasions of dividing the production of the same device among multiple bases is on the rise in recent years.

An example of a technology for controlling a plurality of production bases is described in Patent Literature 1. The technology disclosed in Patent Literature 1 involves predicting delivery and the amount of stock at a point in time that follows a given period, based on a production lead time of each production base and a lead time of a procured material, and determining priority orders of and shipping plans of a produced model for the plurality of production bases, based on the predicted delivery and amount of stock.

### PATENT LITERATURE

Patent Literature 1: JP 2012-141806 A

### SUMMARY

However, PTL1 deals with a technology for determining priority orders of and shipping plans of a produced model, the production of which is divided among a plurality of production bases, and gives no consideration to the possibility of a discrepancy between constraints on production systems at the plurality of production bases. The technology therefore has difficulties with distribution of resources that cause a discrepancy among a plurality of systems.

A disclosed schedule arbitration system includes a first server, a second server, and a schedule arbitration serve.

The first server is configured to send a first scheduling constraint, which is stored in advance, and first schedule information of a given period to a schedule arbitration server, and the second server is configured to send a second scheduling constraint, which is stored in advance, and second schedule information of a given period to the schedule arbitration server.

The schedule arbitration server includes a control unit, which is configured to arbitrate a schedule of the first server and a schedule of the second server, and a storage unit, wherein the storage unit of the schedule arbitration server is configured to store overall optimization constraint information, and wherein the control unit of the schedule arbitration server comprises: an obtaining module configured to obtain the first scheduling constraint and the first schedule information from the first server, and to obtain the second scheduling constraint and the second schedule information from the second server; a discrepancy detection module configured to detect a discrepancy between the first schedule information and the second schedule information, based on the first scheduling constraint, the first schedule information, the second scheduling constraint, and the second schedule information, and on the overall optimization constraint information, which is stored in the storage unit; a schedule recreation module configured to recreate a schedule when a discrepancy is detected, by creating third schedule information and fourth schedule information through modification of the first schedule information and the second schedule information; a credit calculation module configured to calculate a first credit for the first server and a second credit for the second server, based on degrees of modification; and a transmission module configured to send the third schedule information and the first credit to the first server, and configured to send the fourth schedule information and the second credit to the second server. According to this invention, resources can be distributed despite a discrepancy among a plurality of systems.

### BRIEF DESCRIPTION OF THE DRAWINGS

FIG. 1 is an exemplary illustration of the concept of a symbiotic autonomous decentralized system.

FIG. 2 is an exemplary illustration of the configuration of a schedule arbitration system.

FIG. 3 is an exemplary illustration of the hardware configuration of a schedule arbitration server 1 and servers belonging to an autonomous individual server group 2.

FIG. 4 is an exemplary illustration of subjects for which schedules are to be arbitrated in an embodiment of this invention.

FIG. 5-1 is an exemplary illustration of an initial track maintenance schedule.

FIG. 5-2 is an exemplary illustration of an initial light maintenance schedule.

FIG. 5-3 is an exemplary illustration of an initial traffic operation schedule.

FIG. 5-4 is an exemplary illustration of an initial power maintenance schedule.

FIG. 6 is an exemplary illustration of the software configuration of servers belonging to the autonomous individual server group 2.

FIG. 7 is an exemplary illustration of constraint conditions of a schedule.

FIG. 8 is an exemplary illustration of the specifics of a message about an initial maintenance schedule.

FIG. 9 is an exemplary illustration of the software configuration of the schedule arbitration server 1.

FIG. 10-1 is an exemplary illustration of competition between initial maintenance schedules of a track maintenance planning server 2-T and a light maintenance planning server 2-L.

FIG. 10-2 is another exemplary illustration of competition between the initial maintenance schedules of the track maintenance planning server 2-T and the light maintenance planning server 2-L.

FIG. 10-3 is an exemplary illustration of competition between initial maintenance schedules of a power maintenance planning server 2-P and a traffic operation management server 2-O.

FIG. 10-4 is another exemplary illustration of competition between the initial maintenance schedules of the power maintenance planning server 2-P and the traffic operation management server 2-O.

FIG. 11 is an exemplary illustration of a GUI for a scheduling policy viewer.

FIG. 12 is an example of arbitration patterns.

FIG. 13 is an exemplary illustration of a GUI of an “arbitration time input module”.

FIG. 14 is an exemplary illustration of a screen on which priority right point issuing policies are set.

FIG. 15-1 is an exemplary illustration of a modified track maintenance schedule, which is a modification of an initial track maintenance schedule.

FIG. 15-2 is an exemplary illustration of a modified light maintenance schedule, which is a modification of an initial light maintenance schedule.

FIG. 15-3 is an exemplary illustration of a modified power maintenance schedule, which is a modification of an initial power maintenance schedule.

FIG. 15-4 is an exemplary illustration of a modified traffic operation schedule, which is a modification of an initial traffic operation schedule.

FIG. 16 is an exemplary illustration of the specifics of an offer assertion message.

FIG. 17-1 is an exemplary illustration of a comparison between an initial maintenance schedule and schedule constraint conditions (a comparison on the track maintenance server 2-T).

FIG. 17-2 is an exemplary illustration of a comparison between an initial maintenance schedule and schedule constraint conditions (a comparison on the light maintenance server 2-L).

FIG. 18 is an exemplary illustration of an assertion message about a re-proposal.

FIG. 19 is an exemplary illustration of an assertion message in which an offer is rejected.

FIG. 20 is an exemplary illustration of an assertion message in which a schedule is offered.

FIG. 21 is an exemplary illustration of transitions in the state of servers belonging to the autonomous individual server group 2.

FIG. 22 is an exemplary illustration of an assertion message in which only maintenance sections and required times are contained.

FIG. 23 is an exemplary illustration of time slots in which a rejection assertion message tends to be issued.

FIG. 24 is an exemplary illustration of an overall sequence of the schedule arbitration system.

FIG. 25 is an exemplary illustration of the configuration of a valve adjustment system.

FIG. 26 is an exemplary illustration of the configuration of a meeting scheduling system.

FIG. 27-1 is an example of how a schedule of the track maintenance planning server 2-T is modified when points are sent from the track maintenance planning server 2-T to the schedule arbitration server 1.

FIG. 27-2 is an example of how a schedule of the light maintenance planning server 2-L is modified when points are sent from the track maintenance planning server 2-T to the schedule arbitration server 1.

FIG. 28 is a display screen example of the autonomous individual server group 2.

### DETAILED DESCRIPTION OF THE EMBODIMENTS

<Description on the Outline of a Symbiotic Autonomous Decentralized System>

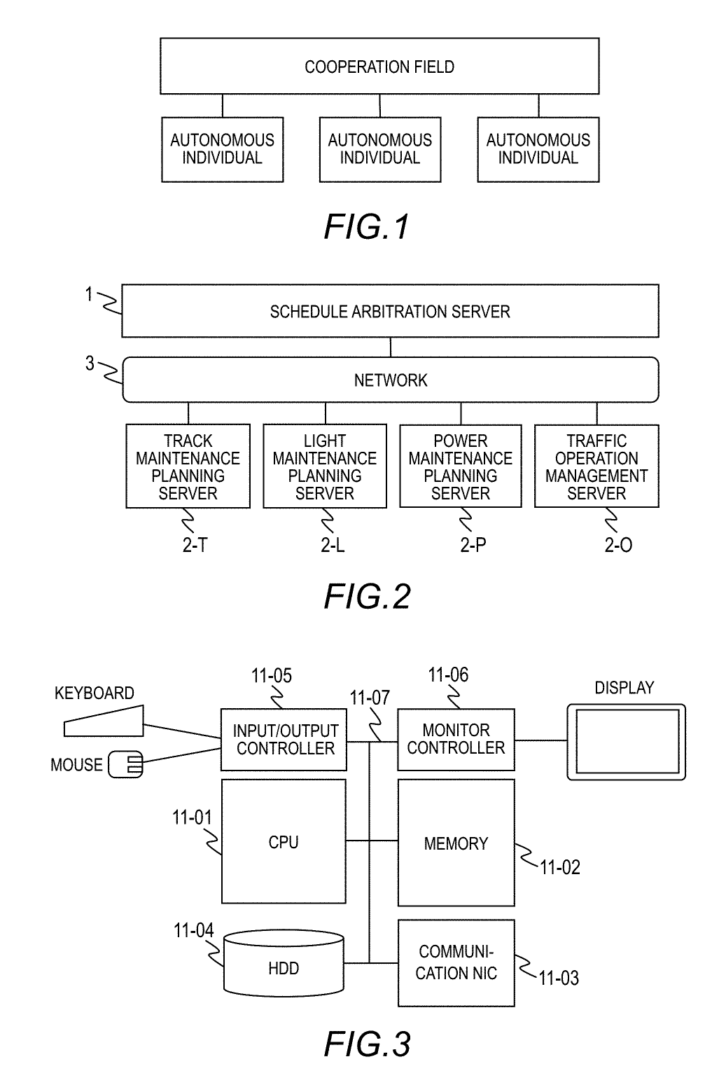

FIG. 1 is a diagram for illustrating the concept of a symbiotic autonomous decentralized system.

New investment on domestic social infrastructure businesses has reached saturation, and fierce competition makes it difficult to enter overseas infrastructure markets as well. In addition, the only effect expected from a merger of corporations or an alliance between business tasks of the same type at present is cost reduction by sharing facilities and services. In light of this, a method is being sought of devising a new service or business that is unheard of by creating a place in which businesses of the same type or different types work together (hereinafter referred to as “field”) and allowing a plurality of existing systems to run symbiotically in the “field”. A system with which symbiosis as this is accomplished is referred to as a symbiotic autonomous decentralized (trademark) system, and a service devised with the system is referred to as a symbiotic autonomous decentralized service.

Actors of different types of or the same type of business tasks in different types of or the same type of businesses are referred to as “autonomous individuals”, and an actor that provides a symbiosis “field” on a server belonging to an autonomous individual server group 2, which is a group of the autonomous individuals, is referred to as a “cooperation field”, as illustrated in FIG. 1.

### First Embodiment

<Application Example of the Symbiotic Autonomous Decentralized System>

FIG. 2 is a diagram for illustrating the configuration of a schedule arbitration system.

A schedule arbitration server 1 corresponds to the “cooperation field”.

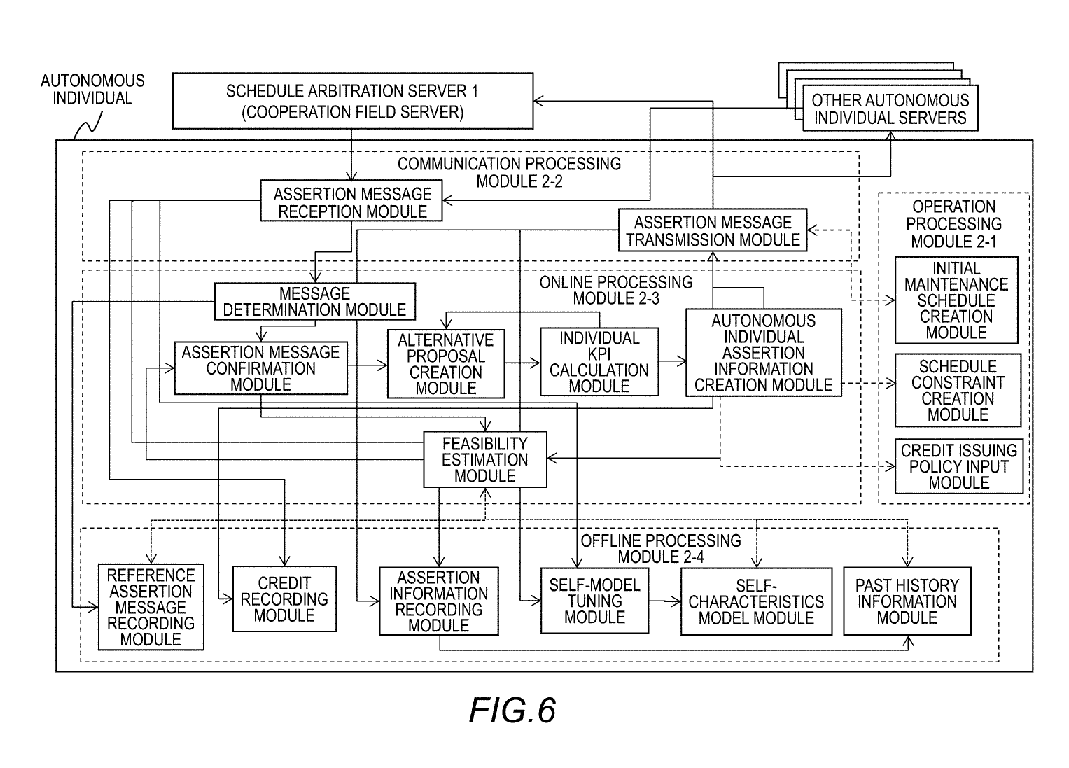

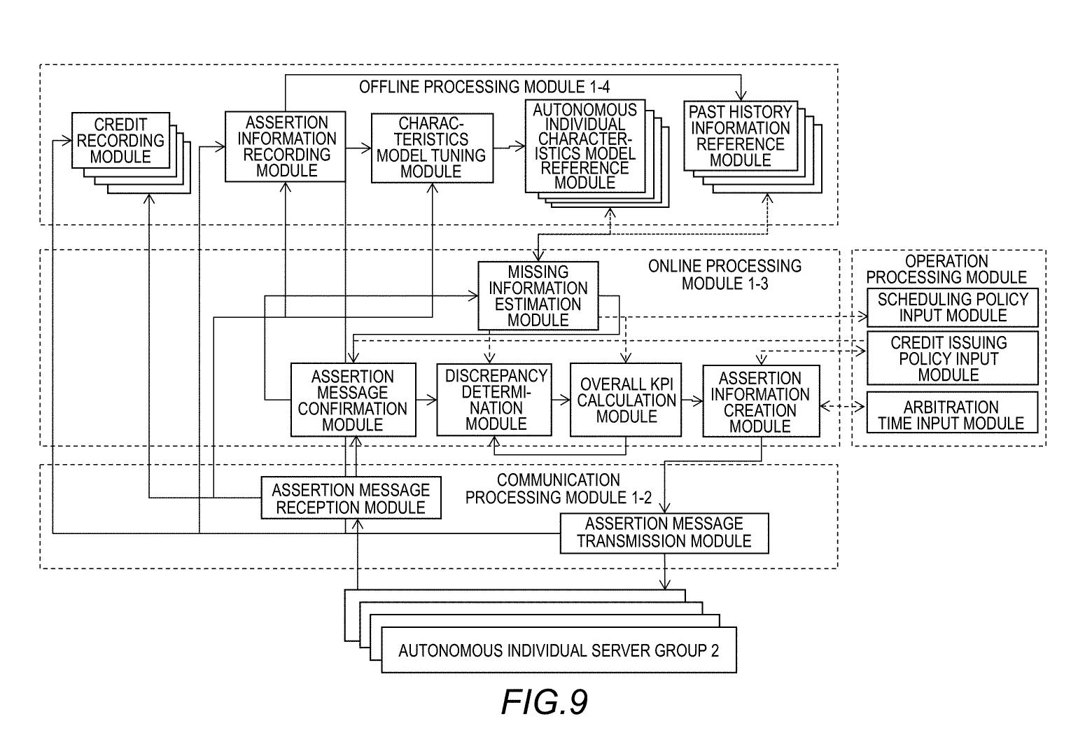

A track maintenance planning server 2-T, a light maintenance planning server 2-L, a power maintenance planning server 2-P, and a traffic operation management server 2-O (which are collectively referred to as “autonomous individual server group 2”), correspond to the “autonomous individuals”. The schedule arbitration server 1 and the autonomous individual server group 2 are coupled to a network 3. Details of an autonomous individual A 2406 to an autonomous individual C 2408 (the autonomous individual server group 2) are described later with reference to FIG. 6. Details of a cooperation field 2405 (the schedule arbitration server 1) are described later with reference to FIG. 9.

Servers in the autonomous individual server group 2 are components of a system for achieving objects of the servers in the autonomous individual server group 2, and the system is referred to as an autonomous individual system. Servers in the autonomous individual server group 2 each have a key performance indicator (KPI), which is referred to as “individual KPI”, for running the autonomous individual system. The autonomous individual system exists in order to reach or maximize individual KPIs of servers in the autonomous individual server group 2. The autonomous individual system can be any system, for example, a railroad traffic management system, a railroad maintenance system, or a power management system, and can be an existing, newly installed, or running system.

The schedule arbitration server 1, too, is a component of a system for achieving an object of the cooperation field, and the system is referred to as a cooperation field system. The cooperation field has a key performance indicator (KPI) for running the cooperation field system, and this KPI is referred to as an “overall KPI”. The cooperation field system exists in order to reach or maximize the overall KPI.

“Symbiosis” in symbiotic autonomous decentralization means a state in which the cooperation field aims to maximize the overall KPI and, at the same time, autonomous individuals coexist while each autonomous individual pursues maximization of its own individual KPI. Ideally, both of the overall KPI and the individual KPIs are maximized concurrently all the time. The overall KPI and the individual KPIs, however, are in a trade-off relation in some cases.

The first embodiment includes a server embodying the cooperation field system (hereinafter referred to as “cooperation field server”) and at least two servers embodying the autonomous individual system (hereinafter referred to as “autonomous individual servers” or “autonomous individual server group”). The cooperation field server and the autonomous individual servers exchange assertion message by following an arbitration protocol. The exchange of assertion messages is hereinafter referred to as “arbitration”.

The term “assertion message” refers to a message in which the assertion of one's demand is written. “Assertion” is an argument made by one while taking the other party's argument into consideration, and differs from a simple “claim” in concept in that “assertion” involves an explanation of one's own situation, a consultation with the other party, and a concession to the other party.

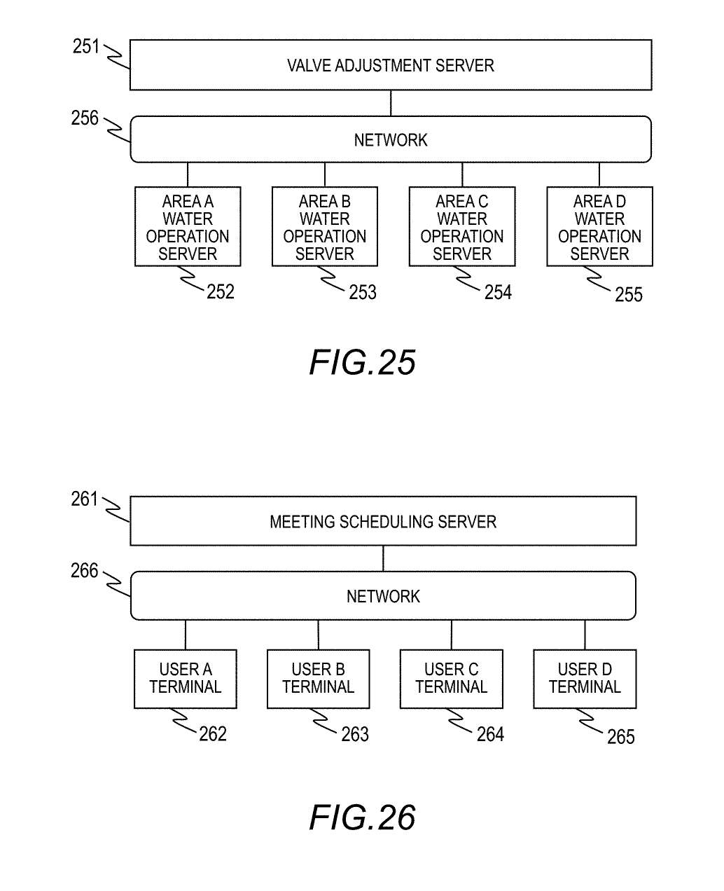

FIG. 25 is a diagram for illustrating the configuration of a valve adjustment system.

The symbiotic autonomous decentralized system in the first embodiment is also applicable to a valve adjustment system.

A valve adjustment server 251 corresponds to the “cooperation field”. An Area A water operation server 252, an Area B water operation server 253, an Area C water operation server 254, and an Area D water operation server 255 correspond to the “autonomous individuals”, and are coupled to a network 256. When the symbiotic autonomous decentralized system in the first embodiment is applied to a valve adjustment system, in order to reduce the total cost of electric power, the valve adjustment server 251 adjusts operation schedules of the water operation servers of the respective areas, and controls the water operation servers of the respective areas control valves by following the adjusted schedules.

FIG. 26 is a diagram for illustrating the configuration of a meeting scheduling system.

The symbiotic autonomous decentralized system in the first embodiment is also applicable to a meeting scheduling system.

A meeting scheduling server 261 corresponds to the “cooperation field”. A User A terminal 262, a User B terminal 263, a User C terminal 264, and a User D terminal 265 correspond to the “autonomous individuals”, and are coupled to a network 266 When the symbiotic autonomous decentralized system in the first embodiment is applied to a meeting scheduling system, in order to coordinate plans of meeting participants, the meeting scheduling server 261 obtains schedule information of each user from the user's terminal, adjusts the date and location of the meeting, and sends information about the date and the location to the terminal of each user.

<Example of Application of the Symbiotic Autonomous Decentralized System to a Schedule Arbitration System>

While application examples as those given above can be considered, an application to the schedule arbitration system illustrated in FIG. 2 is examined in the first embodiment as described below.

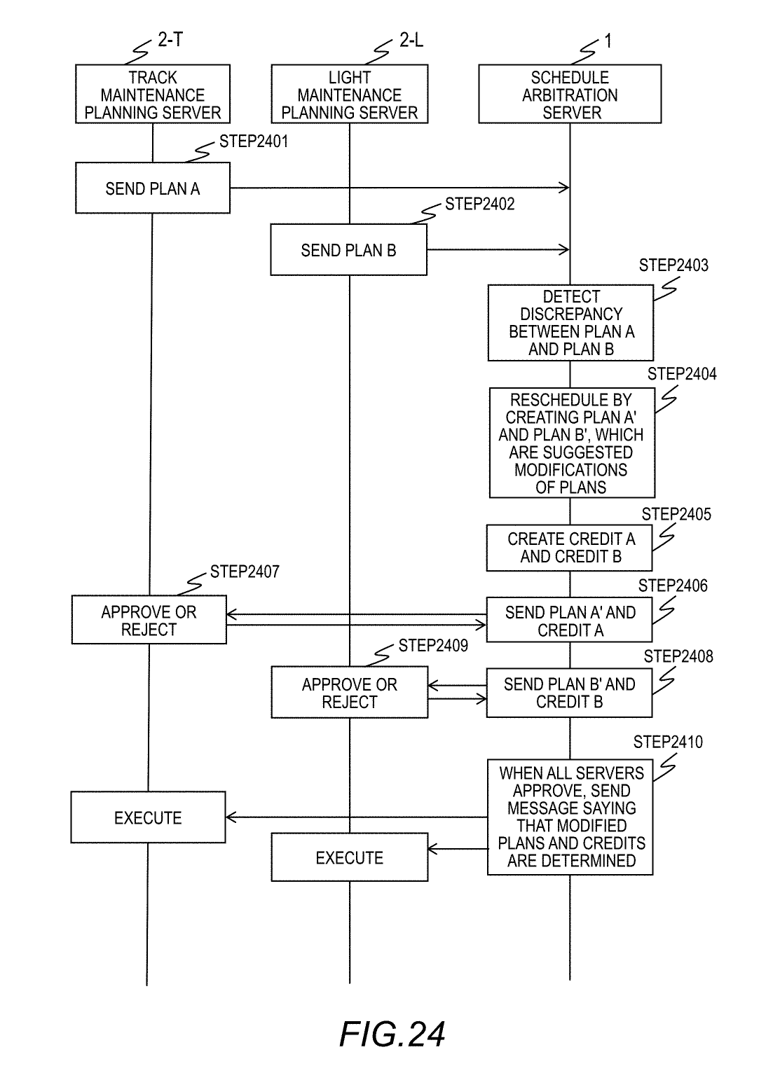

FIG. 24 is an exemplary illustration of an overall sequence of the schedule arbitration system.

The illustrated sequence is the overall sequence observed in an example in which the schedule arbitration server 1 arbitrates schedules of the track maintenance planning server 2-T and the light maintenance planning server 2-L.

The track maintenance planning server 2-T and the light maintenance planning server 2-L send scheduling constraints, which are stored in advance, and pieces of schedule information of a given period (Plan A and Plan B) to the schedule arbitration server 1 (Step 2401 and Step 2402).

In the schedule arbitration server 1, a scheduling policy input module obtains schedule policy information, which is information about a schedule policy of the overall system, and a discrepancy detection module detects a discrepancy between the pieces of schedule information of a given period (Plan A and Plan B), based on the scheduling constraints obtained from the track maintenance planning server 2-T and the light maintenance planning server 2-L and on the schedule policy information (Step 2403). Specifically, Expression 1 is used to detect a schedule conflict between Plan A and Plan B.

$$KPI = \frac{{Σ}_{k = 1}^{n} ( {A}_{k}^{′} {T}_{k}^{′} )}{{Σ}_{k = 1}^{n} ( {A}_{k} {T}_{k} )} \qquad Expression 1$$

In Expression 1, n represents the number of schedules submitted as initial schedules, Aₖ represents a maintenance area indicated in the k-th schedule, and Tₖ represents a k-th time slot. An example of Aₖ is a section of an express highway from one interchange to another interchange. An example of Tₖ is 2 hours from 1 a.m. to 3 a.m.

A′ₖ and T′ₖ represent a maintenance area and a time slot, respectively, in modified schedules, that is, schedules obtained by modifying the initial schedules, that overlap with a maintenance area and a time slot in the initial schedules. The unit of Aₖ may be the number of sections between interchanges, and “minute” in the time slot may be used as the unit of Tₖ. The KPI is accordingly 100% when all parts of an initial schedule are the same as an arbitrated schedule.

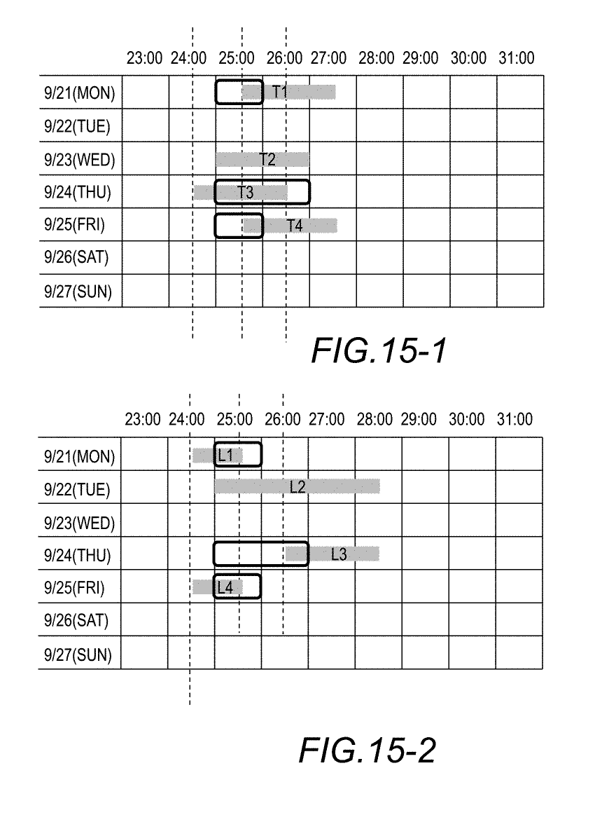

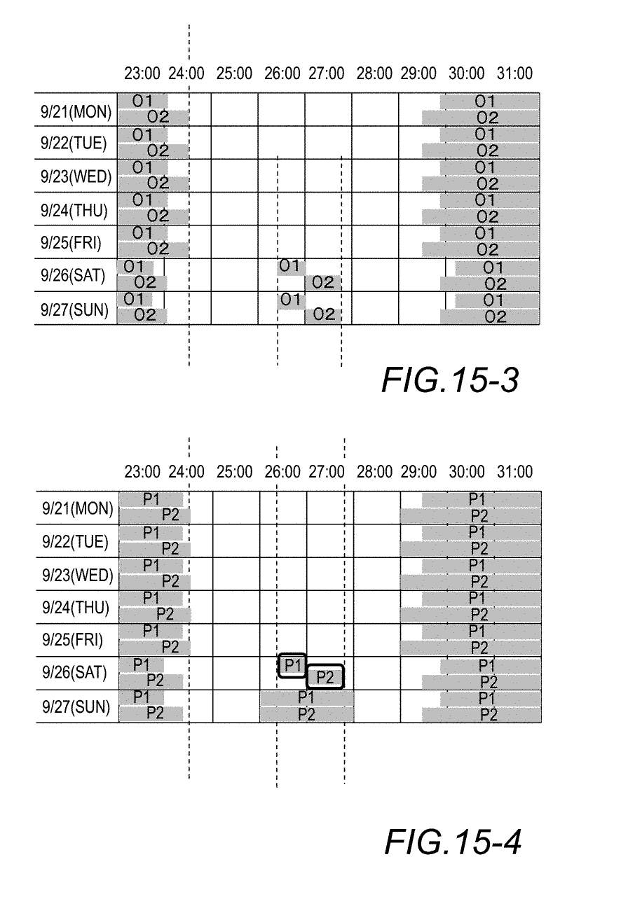

In FIG. 15-1, for example, the length of time in a schedule offered from the cooperation field that overlaps with a time in the initial schedule (8 hours) is 6.5 hours, which means that the KPI is 81.25%.

This definition of the KPI is one of methods favorable for schedule issues, but there is no need to limit how the KPI is defined to this method.

In the schedule arbitration server 1, a storage unit stores overall optimization constraint information in advance, and a credit calculation module modifies the pieces of schedule information (Plan A and Plan B) based on the overall optimization constraint information to recreate pieces of suggested schedule information (Plan A′ and Plan B′) (Step 2404).

The schedule arbitration server 1 calculates credits based on the degree of modification made to the plan (Step 2405). Credits may be calculated by using, as points, the exact number of minutes modified from the initial plan. A transmission module in the schedule arbitration server 1 sends the pieces of suggested schedule information, which are Plan A′ and Plan B′, to the track maintenance planning server 2-T and the light maintenance planning server 2-L, respectively, along with the credits (Step 2406 and Step 2408). The track maintenance planning server 2-T and the light maintenance planning server 2-L display the pieces of suggested schedule information (Plan A′ and Plan B′) on display screens, receive input of approval or rejection, and send results to the schedule arbitration server 1 (Step 2407 and Step 2409). When an approval is obtained from all servers (the track maintenance planning server 2-T and the light maintenance planning server 2-L in this example), the schedule arbitration server 1 sends a message to the effect that the modified plans and the credits are determined (Step 2410). The track maintenance planning server 2-T and the light maintenance planning server 2-L display the determined schedule information and credits, and execute their schedules.

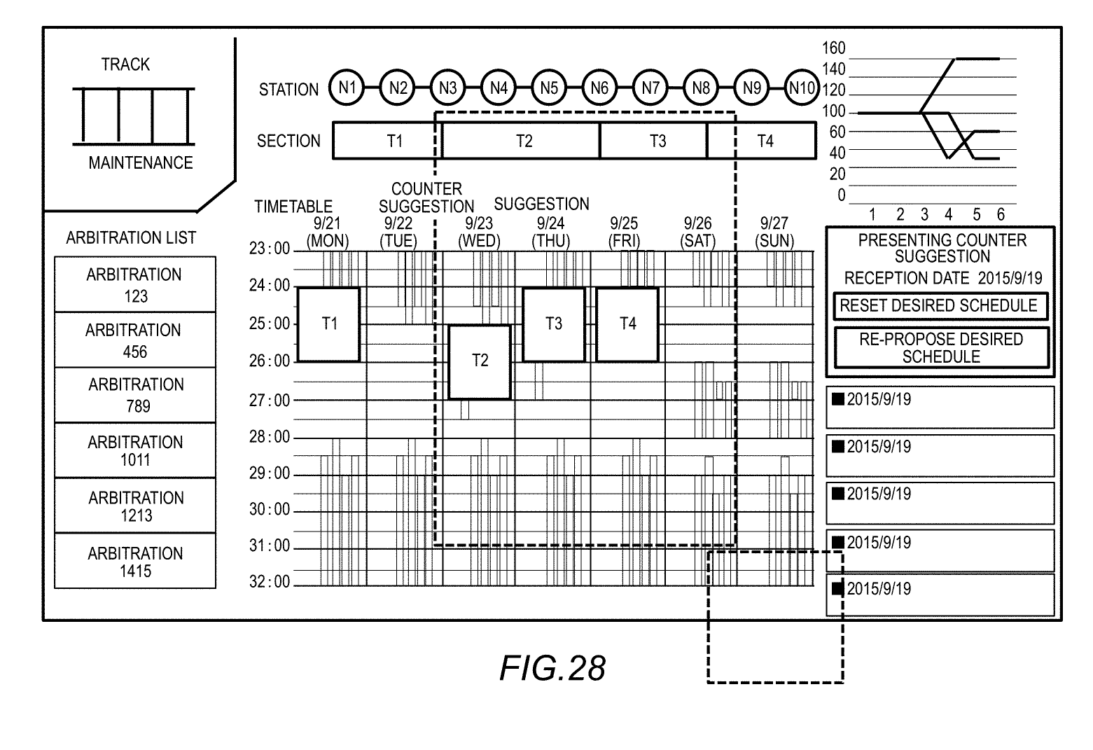

FIG. 28 is a display screen example of the autonomous individual server group 2.

FIG. 3 is a diagram for illustrating the hardware configuration of the schedule arbitration server 1 and the servers in the autonomous individual server group 2.

A CPU 11-01 (a control unit), a memory 11-02 (the storage unit), a communication NIC 11-03, a hard disk drive (hereinafter abbreviated as “HDD”) 11-04, an input/output controller 11-05, and a monitor controller 11-06 are coupled to one another by a bus 11-07 or the like. The input/output controller 11-05 is coupled to a keyboard and a mouse. The monitor controller 11-06 is coupled to a display.

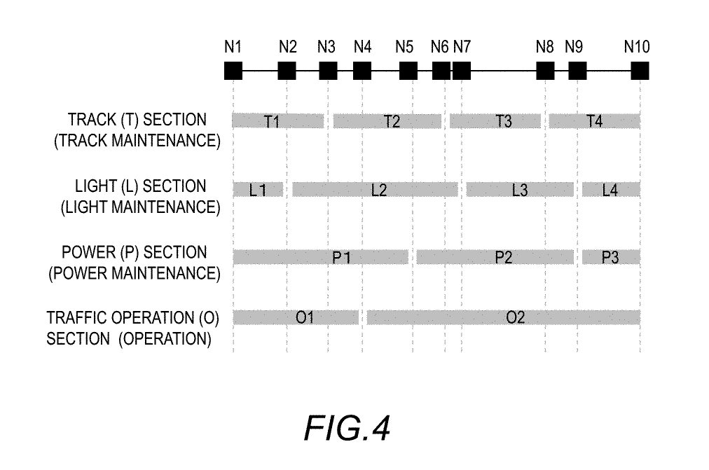

FIG. 4 is a diagram for illustrating a specific example of schedule arbitration in the first embodiment.

Symbols N1 to N10 in FIG. 4 represent interchanges on an express highway. When N1 to N10 represent railroad stations, the line connecting the stations in FIG. 4 represents a rail line of the railroad. A track maintenance section, a light maintenance section, a power maintenance section, and a traffic operation section have one of the stations as a terminal end in the first embodiment. The maintenance sections are the units of performing maintenance tasks.

“Track maintenance” means tasks of maintaining the road surface of an express highway. For example, the work of raising a road, which keeps sinking lower due to the weights of vehicles, is one of the road surface maintenance tasks.

“Light maintenance” means tasks of maintaining the light of an express highway. For example, the work of replacing a broken light, or a light that has been in place for a given period, is one of the light maintenance tasks.

“Power maintenance” means a repair or replacement of an electric device that is conducted for a stable supply of electric power to points along an express highway. “Traffic operation” means matters related to traffic control of automotive vehicles. In the first embodiment, however, a power maintenance section and a traffic operation section are treated as a section in which electricity flows and a section in which the traffic of automobiles is controlled, respectively.

For example, track maintenance is conducted with the interchanges N1 to N3 as one task unit (T1). While it is not allowed to conduct two track maintenance tasks in the section T1, a maintenance task in the section T1 and a maintenance task in a section T2 can be conducted at the same time.

The track maintenance section T1 and a light maintenance section L1, on the other hand, are overlapping sections, and a track maintenance task in T1 and a light maintenance task in L1 cannot be conducted at the same time.

In addition, track maintenance workers and light maintenance workers are prohibited from performing tasks while electricity is running in relevant sections, for the purpose of ensuring the safety of the workers. Specifically, maintenance tasks can be conducted in none of the section T2, the section L1, and a section L2 during the time in which electricity is running in a power section P1.

On the other hand, automobiles may not be able to travel without electricity running. It is therefore required in some cases to run electricity in the power section P1 while traffic control of automobiles is conducted in a traffic operation section O1. Schedule arbitration here is also set so that track maintenance and light maintenance are prohibited during traffic control of automobiles.

In the first embodiment, the understanding of a mode of carrying out this invention is helped out by intentionally simplifying settings as follows:

First, the mode is set so that track maintenance schedule, light maintenance schedule, power maintenance schedule, and traffic operation schedule are adjusted once a week. In actuality, however, the schedules to be arbitrated may span a longer period (a month or six months). Similarly, while the mode is set so that track maintenance and light maintenance each have only one maintenance task actor (maintenance team), two or more maintenance teams may conduct tasks in different maintenance sections of the same maintenance type at the same time in actuality.

Schedule adjustment set as above desirably does not deviate much from maintenance schedules initially suggested by the respective autonomous individual servers (hereinafter referred to as “initial maintenance schedules”). This is because each company that handles one of the types of maintenance tasks (hereinafter referred to as “maintenance company”) is likely to set a schedule most convenient to the maintenance company that maximizes the individual KPI.

Specifically, a date and time convenient to a maintenance worker, a distance from a location at which maintenance workers report to work to the site of the maintenance task, and the like are considered to be reflected on the schedule, because the travel of a maintenance worker, overtime work, and business hours affect cost.

For each autonomous individual server in the autonomous individual server group 2, the initial maintenance schedule of the autonomous individual server is accordingly taken as the “individual KPI” in the first embodiment. A state in which arbitration is completed without changing any part of an initial maintenance schedule is considered as a “state in which the maximization of the individual KPI is accomplished”.

When the place or time of a track maintenance task and the place or time of a light maintenance task overlap, one of the maintenance tasks is required to be canceled. The cancellation means a failure to maximize the individual KPI, and the track maintenance company or the light maintenance company accordingly regards the cancellation as a detriment.

A state in which “the overall KPI is maximized” in the schedule arbitration server 1 is considered as a state in which every one of the initial schedules submitted from all autonomous individuals is employed by arbitration among the autonomous individuals.

An object of this system is to accomplish the maximization of the KPI of the schedule arbitration server 1 and the maximization of the individual KPIs of the autonomous individual servers at the same time.

First, each server belonging to the autonomous individual server group 2 and managing one of the types of maintenance tasks sends a desired schedule to the schedule arbitration server 1 by a given date and time in order to determine the maintenance schedule for the next week.

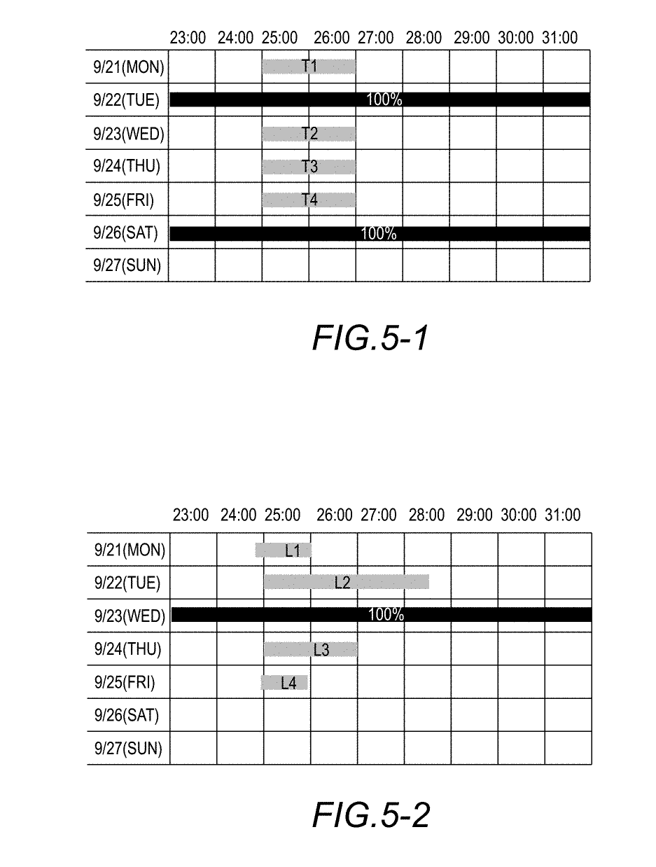

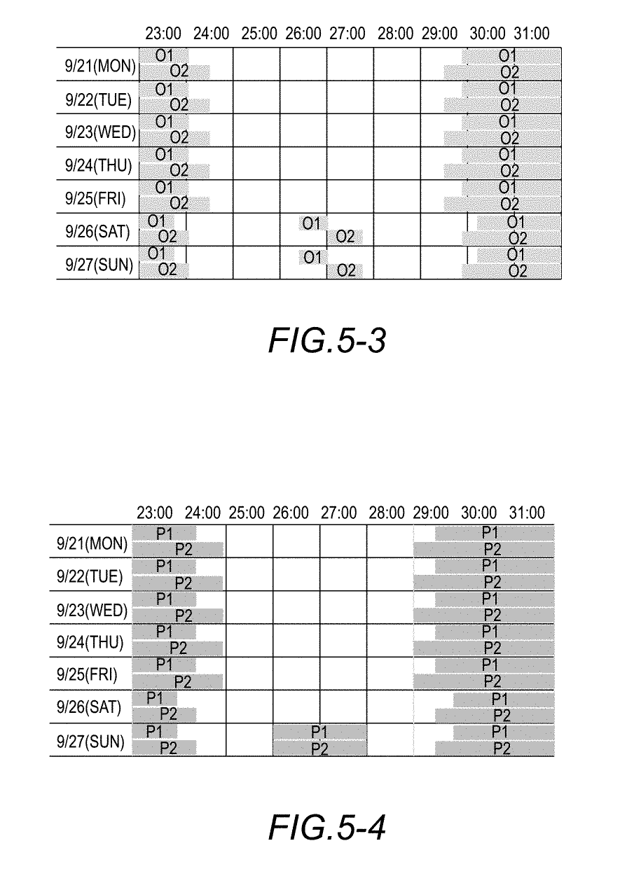

FIG. 5-1 is a diagram for illustrating an initial track maintenance schedule. FIG. 5-2 is a diagram for illustrating an initial light maintenance schedule. FIG. 5-3 is a diagram for illustrating an initial traffic operation schedule. FIG. 5-4 is a diagram for illustrating an initial power maintenance schedule.

FIG. 6 is a diagram for illustrating the configuration of software stored in the memory 11-02 of each server in the autonomous individual server group 2. Each arrow in FIG. 6 indicates a relation between software modules in which one software module is called up or referred to by the other software module, and is also understood as an algorithm of a program.

The illustrated programs are loaded on the memory 11-02 of FIG. 3 to be executed by the CPU 11-01. Storage information required by modules of a communication processing module 2-2 and modules of an online processing module 2-3 is stored in the memory 11-02. Storage information required by modules of an offline processing module 2-4, on the other hand, is stored not only in the memory 11-02 but also in the HDD 11-04.

An operation processing module 2-1 includes an “initial maintenance schedule creation module”, which creates an initial maintenance schedule of its own server belonging to the autonomous individual server group 2. The initial maintenance schedule may be created by an operator who operates the display, keyboard, and mouse of FIG. 3, with the use of a given tool. The created initial maintenance schedule is stored in an “assertion message transmission module” of the communication processing module 2-2.

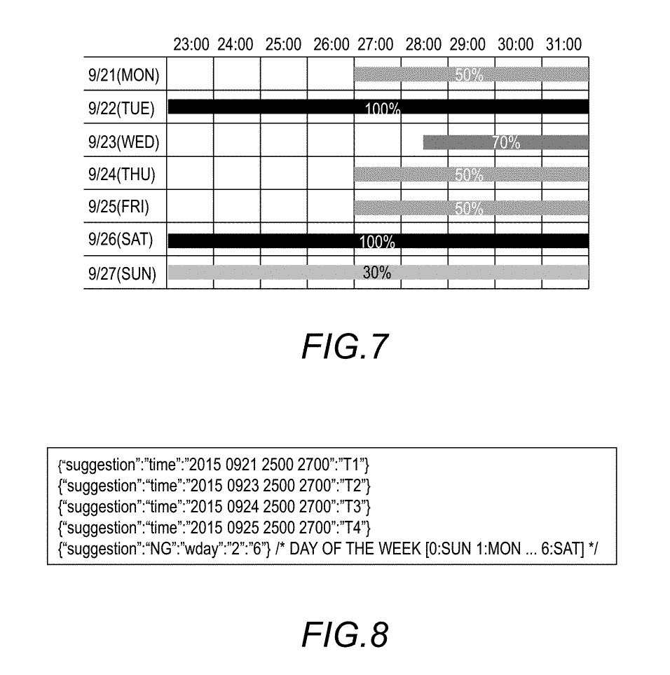

FIG. 7 is a diagram for illustrating constraint conditions of a schedule (hereinafter referred to as “schedule constraint conditions”), in this case, a track maintenance schedule.

On September 22nd (Tue) and September 26th (Sat), which are regular holidays, the fact that there is zero chance of maintenance tasks being conducted is indicated by “100%”. A weight of 30%, a weight of 70%, and a weight of 50% indicate the degrees of difficulty of conducting maintenance tasks on September 27th (Sun), on September 23rd (Wed) past 28:30, and on September 24th (Thu) past 27:00, respectively. The numerical values indicating the degrees of difficulty are determined by a policy of a maintenance company that runs the relevant autonomous individual server. Examples of an indicator for the policy include a numerical value that is obtained by taking into account an additional cost (an overtime pay or a travel cost) incurred from conducting a maintenance task in a time slot of interest.

The schedule constraint conditions are created by a “schedule constraint condition creation module”, which is included in the operation processing module 2-1, and is transferred to a “feasibility estimation module”, which is included in the online processing module 2-3. The schedule constraint conditions, too, may be created by an operator with the use of a given tool as in the case described above. In each autonomous individual server, the initial maintenance schedule of the autonomous individual server is transmitted from the “assertion message transmission module”, which is included in the communication processing module 2-2 of the autonomous individual server as illustrated in FIG. 6.

FIG. 8 is a diagram for illustrating the specifics of a message about an initial maintenance schedule (a suggestion assertion message) of the track maintenance planning server 2-T, which is one of the servers belonging to the autonomous individual server group 2.

In FIG. 8, each line from the first line to the fourth line indicates a maintenance task time slot and a maintenance task section. The first line is a description of an initial suggestion in which a maintenance task is scheduled for the section T1 in a time slot from 25:00 to 27:00 on September 21st, 2015. The fifth line is a description that sets Tuesdays and Saturdays as days on which maintenance tasks cannot be conducted because of, for example, regular holidays of the maintenance company. On such days, the track maintenance planning server 2-T always rejects arbitration performed by the schedule arbitration server 1. However, regular holiday information as this is not required to be written while a description of an initial maintenance schedule is indispensable. Similar tasks are conducted also by the light maintenance planning server 2-L, the power maintenance planning server 2-P, and the traffic operation management server 2-O.

FIG. 9 is a diagram for illustrating the configuration of software loaded on the memory 11-02 of the schedule arbitration server 1. Each arrow in FIG. 9 indicates a relation between software modules in which one software module is called up or referred to by the other software module, and is also understood as an algorithm of a program. The illustrated programs are loaded on the memory 11-02 of FIG. 3 to be executed by the CPU 11-01. Storage information required by modules of a communication processing module 1-2 and modules of an online processing module 1-3 is stored in the memory 11-02. Storage information required by modules of an offline processing module 1-4, on the other hand, is stored not only in the memory 11-02 but also in the HDD 11-04.

From each autonomous individual server belonging to the autonomous individual server group 2, an assertion message about an initial maintenance schedule (a suggestion assertion message) of the autonomous individual server is sent over the network 3 to be received by an “assertion message reception module” of the communication processing module 1-2 in the schedule arbitration server 1 and an “assertion message reception module” of the communication processing module 2-2 in each of the other autonomous individual servers belonging to the autonomous individual server group 2.

This assertion message is transferred to an “assertion message confirmation module” of the online processing module 1-3 to receive a format check, and is corrected when there is a defect in the format.

The checked information is further sent to a “missing information estimation module”. The assertion message in this case does not have missing information, and is consequently returned to the “assertion message confirmation module” as it is.

When assertion messages about initial maintenance schedules (suggestion assertion messages) of the track maintenance planning server 2-T, the light maintenance planning server 2-L, and the power maintenance planning server 2-P, and an assertion message about an initial schedule (suggestion assertion message) of the traffic operation management server 2-O all arrive, the “assertion message confirmation module” of the online processing module 1-3 transfers the initial maintenance schedules and the initial traffic operation schedule to a “discrepancy determination module”. The “discrepancy detection module” checks for a conflict between schedules (hereinafter referred to as “competition”).

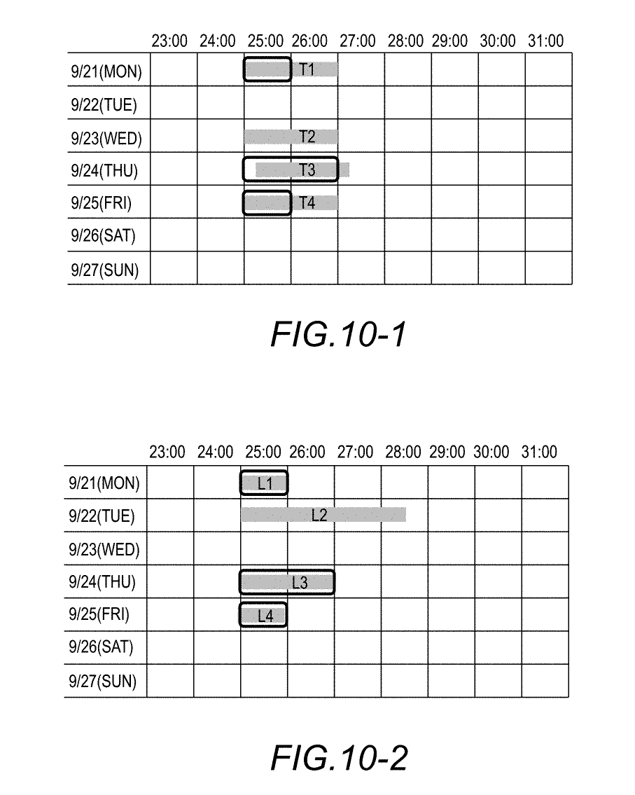

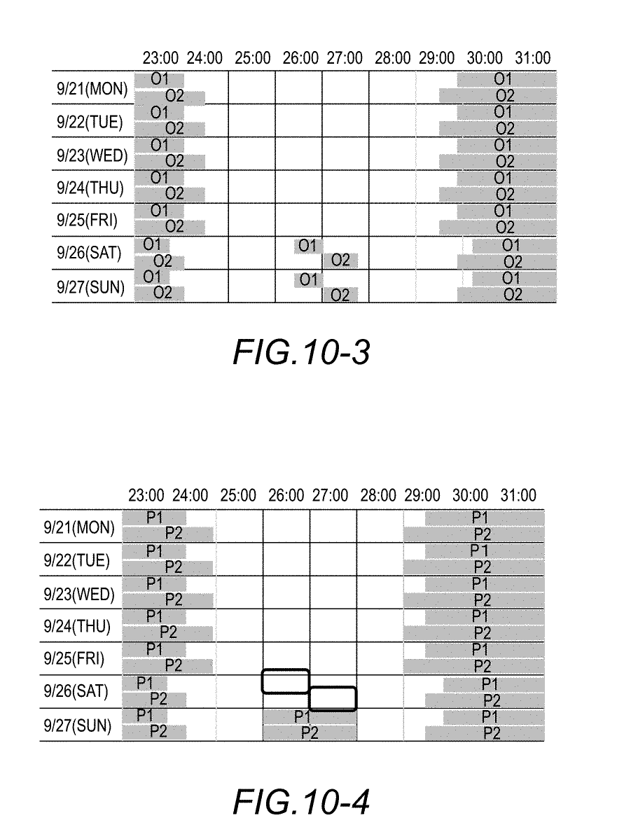

FIG. 10-1 and FIG. 10-2 are diagrams for illustrating competition between an initial maintenance schedule of the track maintenance planning server 2-T and an initial maintenance schedule of the light maintenance planning server 2-L. A comparison between the maintenance sections of FIG. 4 and the initial maintenance schedules reveals competition between maintenance in the section T1 and maintenance in the section L1 on September 21st (Mon). Competition is also found between maintenance in a section T3 and maintenance in a section L3 on September 24th (Thu), and between maintenance in a section T4 and maintenance in a section L4 on September 25th (Fri).

FIG. 10-3 and FIG. 10-4 are diagrams for illustrating competition between an initial maintenance schedule of the power maintenance planning server 2-P and an initial schedule of the traffic operation management server 2-O. It is understood from the drawing that electricity is not running in a part of a period from 26:00 to 28:00 on September 26th (Sat) when there is traffic of vehicles.

The initial maintenance schedules and the initial traffic operation schedule are input to an “alternative proposal creation module” of the online processing module 1-3, and alternative schedules are created. When an alternative proposal is to be created, a scheduling policy is presented in advance by a “scheduling policy input module” of the operation processing module 1-1.

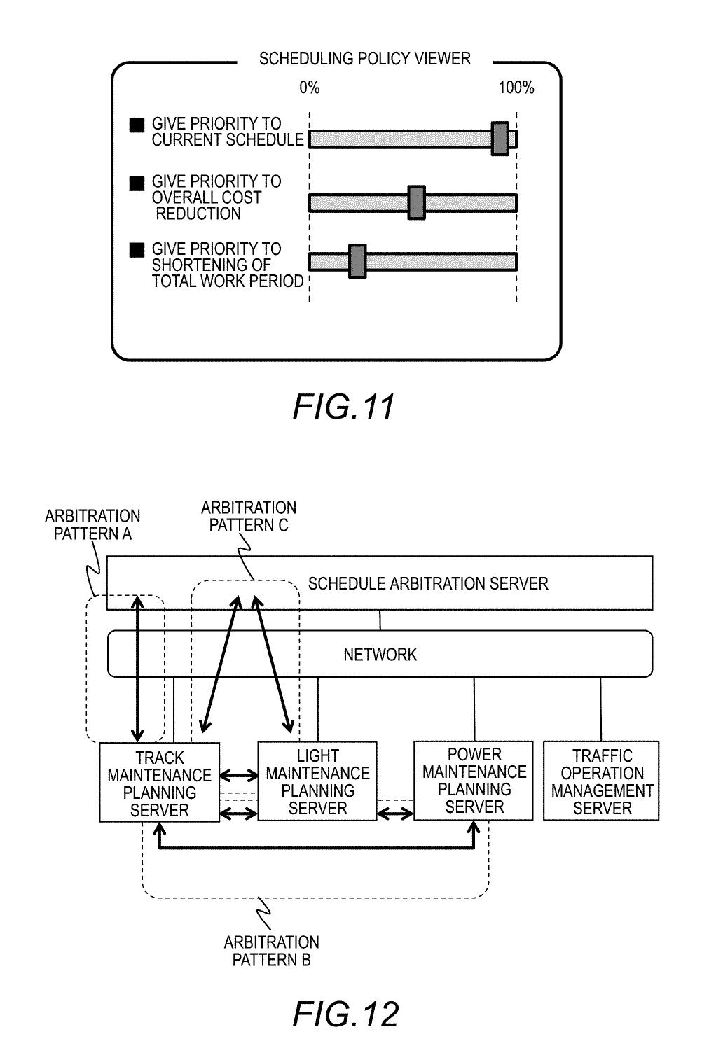

FIG. 11 is a diagram for illustrating a GUI for a scheduling policy viewer to give an example of scheduling policies displayed on the display of FIG. 3 in the autonomous individual server group 2. FIG. 12 is an illustration of patterns of arbitration among the schedule arbitration server 1, which behaves as a cooperation field server, and autonomous individual servers belonging to the autonomous individual server group 2, in this case, the track maintenance planning server 2-T and the light maintenance planning server 2-L. Specifically, points equivalent to the number of minutes in which a server has failed to stay within constraints (a KPI) are given to the server that has failed to stay within constraints, out of the schedule arbitration server 1 and the servers in the autonomous individual server group 2. When priority right points are presented, schedules are arbitrated in a manner that enables a server that presents the most priority right points among the schedule arbitration server 1 and the servers in the autonomous individual server group 2 to stay within its constraints.

Arbitration Pattern A represents a state in which, while there is no competition between servers belonging to the autonomous individual server group 2, competition arises between the schedule arbitration server 1 and one of the servers in the autonomous individual server group 2 due to a desire to maximize its own KPI on each server's part. When schedules are not arbitrated successfully despite repeated attempts, the schedule arbitration server 1 or the server in the autonomous individual server group 2 is allowed to claim a priority right based on credits (hereinafter referred to as “priority right points”) that belong to itself.

Priority right points can be understood as a common currency, which is usable between the schedule arbitration server 1 and the autonomous individual server group 2. Competition between claims for priority right is resolved by granting the claim for priority right of the server that is higher in the number of points, which is the amount of this currency.

A quantification of this priority right is “priority right points” in the first embodiment. Priority right points are based on “time (minutes)”, which are resources handled in arbitration. When a part of schedules to be arbitrated is a time period of 30 minutes, the value of the time period is around 30 points as a general rule. This value in points is determined fluidly by the schedule arbitration server 1 or the server in the autonomous individual server group 2, which desires this time period, and a value of 30 points is therefore merely a rough standard. The schedule arbitration server 1, which wishes for the server in the autonomous individual server group 2 to accept an arbitration proposal, or the server in the autonomous individual server group 2, which wishes for the schedule arbitration server 1 to accept its initial suggestion or re-proposal, claims the priority right by presenting a suggestion with points (a numerical value). The suggestion or re-proposal of the server that presents more points is adopted in order to resolve the competition, and the points are transferred to the server whose suggestion or re-proposal is not adopted. In other words, the server whose suggestion or re-proposal is not adopted can use the transferred points to claim the priority right in another chance. For example, priority right points are sent along with an initial maintenance schedule when initial maintenance schedules are sent from the autonomous individual server group 2 to the schedule arbitration server 1 (Step S2401 of FIG. 24).

Arbitration Pattern B represents a state in which competition arises between two or more servers in the autonomous individual server group 2 that wish to maximize their own KPIs without affecting the KPI of the schedule arbitration server 1. When schedules are not arbitrated successfully despite repeated attempts, the competing servers in the autonomous individual server group 2 are each allowed to claim a priority right based on priority right points that belong to itself, by submitting a re-proposal with the points. The schedule arbitration server 1 performs arbitration based on the points presented by the competing servers in the autonomous individual server group 2. In this arbitration, one of the competing autonomous individuals may make a re-proposal in which the degree of influence on another autonomous individual or the like is taken into account for another round of arbitration. The simplest method is to preferentially adopt a suggestion that gives the most points.

The points of one of the competing servers in the autonomous individual server group 2 whose suggestion is accepted are distributed to the rest of the competing servers in the autonomous individual server group 2 whose suggestions are not accepted. The points of the one autonomous individual may be distributed by taking into account the degree of influence on another autonomous individual. The simplest way is to distribute equally divided points.

Arbitration Pattern C represents a state in which the KPI of the schedule arbitration server 1 and the KPIs of two or more servers in the autonomous individual server group 2 all affect one another, and there is competition among the schedule arbitration server 1 and the two or more autonomous individual servers. When schedules are not arbitrated successfully despite repeated attempts, the schedule arbitration server 1 and the competing servers in the autonomous individual server group 2 are each allowed to claim a priority right based on points that belong to itself, by submitting a re-proposal with the points. The schedule arbitration server 1 performs arbitration based on the points presented by the schedule arbitration server 1 and the points presented by the competing servers in the autonomous individual server group 2. The method of arbitration and how the points are distributed are as described above.

The arbitration states are disclosed to all servers belonging to the autonomous individual server group 2, instead of limiting the information to the schedule arbitration server 1. Specifically, all assertion messages including a suggestion for arbitration and a re-proposal are transferred to all servers belonging to the autonomous individual server group 2 so that the fairness in arbitration can be monitored by all servers in the symbiotic autonomous decentralized system.

However, the arbitration states may be kept secret when, for example, the disclosure of arbitration information is equivalent to the disclosure of trade secret information of servers in the autonomous individual server group 2.

Each server can submit a re-proposal and increase points to be presented as many times as desired, as long as a time period specified by the schedule arbitration server 1 is not exceeded, but is not allowed to withdraw the submitted re-proposal and the increased points later.

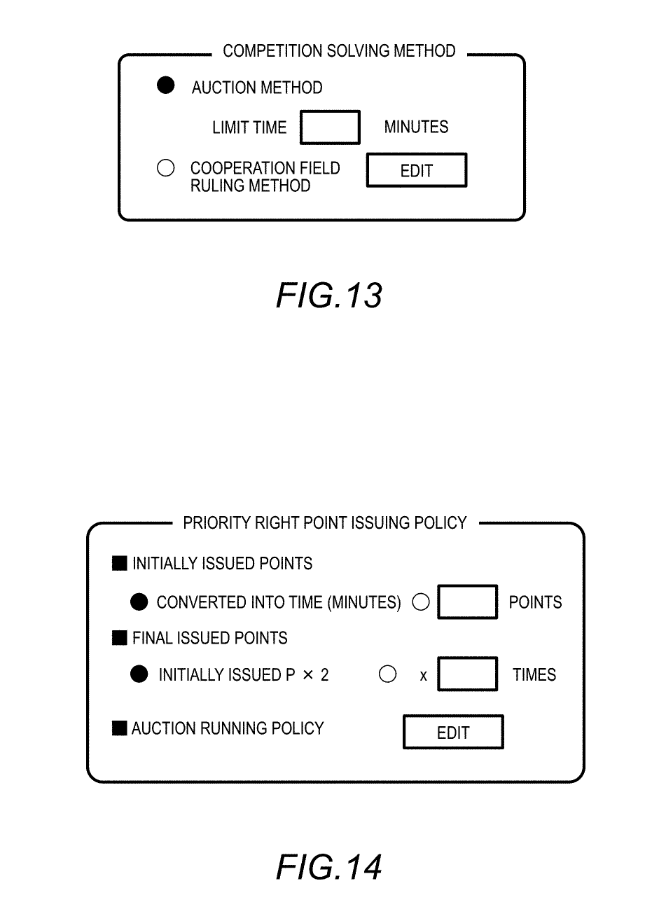

FIG. 13 is a diagram for illustrating a GUI of an “arbitration time input module”, which is included in the operation processing module 1-1 of FIG. 9. Specification methods of two types, an “auction method” and a “cooperation field ruling method”, are illustrated, but this invention is not limited thereto. The “auction method” allows one of the schedule arbitration server 1 and an autonomous individual that has presented the best condition along with a claim for the priority right by a given time to secure its desired time slot. The “cooperation field ruling method” allows the schedule arbitration server 1 to specify a condition by its own rule. For example, the schedule arbitration server 1 determines, in advance, an upper limit to points and, when the upper limit points are reached, can determine which actor is permitted to claim the priority right. The condition can be edited with, for example, editor software displayed on the screen when an edit button is pressed.

FIG. 14 is a diagram for illustrating a screen on which priority right point issuing policies observed by the schedule arbitration server 1 and all servers in the autonomous individual server group 2 are set. The policies are input from a “priority right point issuing policy input module” of the operation processing module 2-1 of FIG. 6, and a “priority right point issuing policy input module” of the operation processing module 1-1 of FIG. 9.

The initial value of priority right points is set to “initially issued points”. The default value of “initially issued points” is a value that is the length of time (minutes) in which competition lasts, but may be set manually by an operator. The maximum value of priority right points is set to “final issued points”. The default value of “final issued points” is a value that is a double of the length of time (minutes) in which competition lasts, but an operator may manually input the value of a multiple.

However, the schedule arbitration server 1 and the servers in the autonomous individual server group 2 are each prohibited from presenting more priority right points than the priority right points owned by itself. The server stops adding to presented points when this upper limit is reached.

A script in which the number of times an auction is divided and various auction strategies, including presenting many points at the start time or immediately before the auction ends, are written can be read onto as an “auction running policy”.

The “discrepancy determination module” in the online processing module 1-3 of FIG. 9 follows a scheduling policy of the “scheduling policy input module” in the operation processing module 1-1 to create a new schedule, which avoids schedule competition, and hands over the new schedule to an “overall KPI calculation module”. Based on the new schedule, the “overall KPI calculation module” creates a further new schedule, which maximizes the overall KPI.

If competition arises in a schedule, the schedule is returned to the “discrepancy detection module”. The “discrepancy detection module” and the “overall KPI calculation module” work together so that schedules converge while repeating the processing.

FIG. 15-1, FIG. 15-2, FIG. 15-3, and FIG. 15-4 are diagrams for illustrating an example of a track maintenance schedule, a light maintenance schedule, a power maintenance schedule, and a traffic operation schedule in which competition is avoided by modifying an initial track maintenance schedule, an initial light maintenance schedule, an initial power maintenance schedule, and an initial traffic operation schedule on the schedule arbitration server 1. In other words, FIG. 15-1 is an example of a modified track maintenance schedule, FIG. 15-2 is an example of a modified light maintenance schedule, FIG. 15-3 is an example of a modified power maintenance schedule, and FIG. 15-4 is an example of a modified traffic operation schedule.

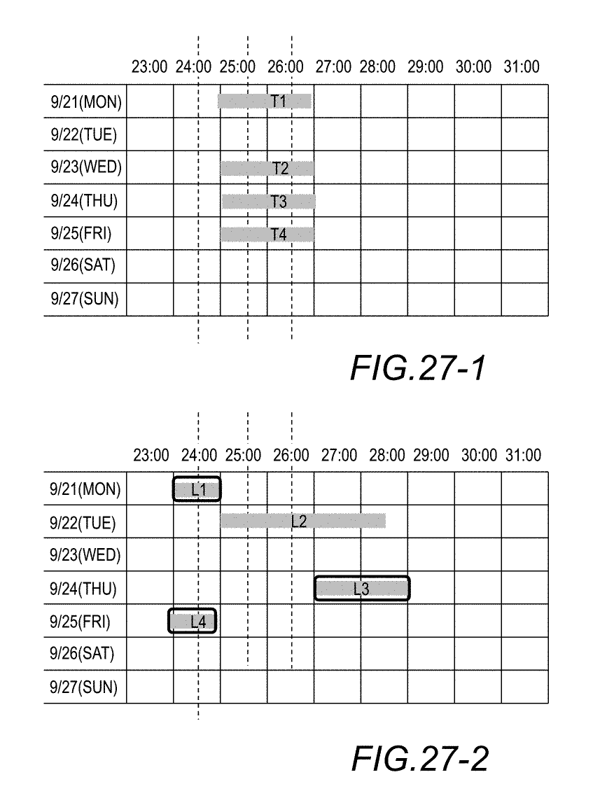

FIG. 27-1 is an example of how a schedule of the track maintenance planning server 2-T is modified when points are sent from the track maintenance planning server 2-T to the schedule arbitration server 1.

FIG. 27-2 is an example of how a schedule of the light maintenance planning server 2-L is modified when points are sent from the track maintenance planning server 2-T to the schedule arbitration server 1.

A case is described in which schedule information of 15-1 is sent from the schedule arbitration server 1 to the track maintenance planning server 2-T, and the track maintenance planning server 2-T rejects the schedule information. The track maintenance planning server 2-T sends schedule information as a re-proposal and points to the schedule arbitration server 1. When the points sent from the track maintenance planning server 2-T are more than points of any other autonomous individual server (the light maintenance planning server 2-L in this case), the schedule information sent from the track maintenance planning server 2-T as a re-proposal is permitted, and further modifications are made to schedule information of other autonomous individual servers (the light maintenance planning server 2-L in this case). In other words, re-modified schedule information of the track maintenance planning server 2-T is FIG. 27-1, and re-modified schedule information of the light maintenance planning server 2-L is FIG. 27-2. The modified schedule of the light maintenance planning server 2-L is obtained by modifying 240 minutes of the initial maintenance schedule, which means that 240 points are given.

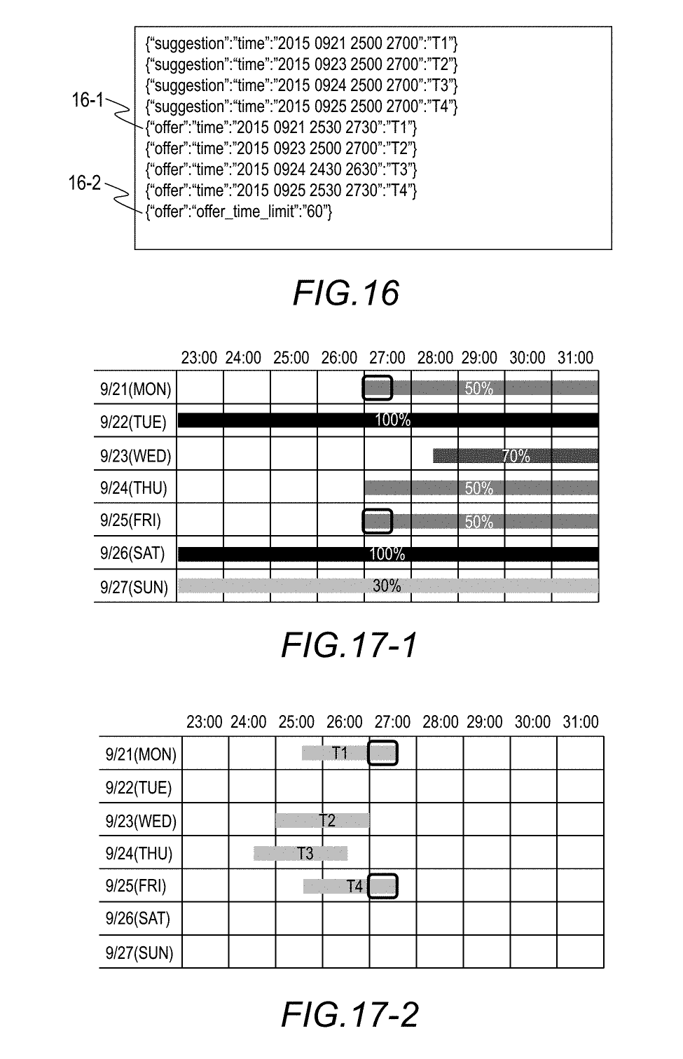

FIG. 16 is a diagram for illustrating the specifics of an offer assertion message of FIG. 15-1, which is sent from the schedule arbitration server 1 in response to the suggestion assertion message of FIG. 8, which is a message from the track maintenance planning server 2-T about the initial track maintenance schedule (16-1). A limit time of 60 minutes by which a response to the offer assertion message is required to be sent is also specified (16-2).

The offer assertion message is transferred to the “assertion message transmission module” in the communication processing module 2-2 of the track maintenance planning server 2-T of FIG. 6, and is distributed as a first arbitration result to all servers in the autonomous individual server group 2. By distributing the arbitration result to all autonomous individual servers, each server in the autonomous individual server group 2 can know the specifics of arbitration made to other autonomous individuals, and can check to see whether the server alone is treated disadvantageously. However, the arbitration result may be handled as secret communication if necessary as described above.

An assertion message received by the “assertion message reception module” in the communication processing module 2-2 of FIG. 6 and an assertion message transmitted from the “assertion message transmission module” are recorded by an “assertion information recording module” of the offline processing module 2-4. The record is stored in a “past history information module” of the offline processing module 2-4. The assertion message is also transferred to a “self-model tuning module” of the offline processing module 2-4. The “self-model tuning module” extracts, from the assertion message, information required for model tuning, and the extracted information is used to tune a characteristics model of its own autonomous individual server.

The assertion message described above, which is sent from the schedule arbitration server 1 or a server in the autonomous individual server group 2, is received by the “assertion message reception module” in the communication processing module 2-2 of the autonomous individual server of FIG. 6, and is transferred to the “assertion message confirmation module” of the online processing module 2-3. The assertion message is further transferred to the “feasibility estimation module” to be compared to schedule constraint conditions created by the “schedule constraint condition creation module” of the operation processing module 2-1.

FIG. 17-1 and FIG. 17-2 are diagrams of a comparison in which the schedule arbitration server 1 compares initial maintenance schedules and schedule constraint conditions.

In other words, FIG. 5-1 and FIG. 5-2 are compared with FIG. 15-1 and FIG. 15-2, respectively.

FIG. 17-1 is a comparison result for the track maintenance planning server 2-T, and FIG. 17-2 is a comparison result for the light maintenance planning server 2-L.

The 50% constraint condition is infringed on from 27:00 to 27:30 on September 21st (Mon) and September 25th (Fri), as illustrated in FIG. 17-1. The track maintenance planning server 2-T has a choice to reject this schedule, but it is not impossible for the track maintenance planning server 2-T to accept this new schedule. However, the new schedule increases the cost of maintenance tasks. The “feasibility estimation module” of the online processing module 2-3 accordingly re-proposes the same schedule, with priority right points that cover the increased cost attached to the proposal, to the schedule arbitration server 1 in a “re_suggestion_with_priority assertion message”. The modified schedule of the track maintenance planning server 2-T is obtained by modifying 30 minutes of the initial maintenance schedule, which means that 30 points are given.

An assertion message of the type “_with_priority” is a server's proposal to provide priority right points owned by the server in order to make the other party agree with the server's demand, and can use priority right points having a minus value as a method of demanding the other party to proffer priority right points. In other words, instead of asking the other party to “accept a re-proposal in exchange for ∘∘ points”, the server may inform the other party of the server's “willingness to accept a re-proposal as such if the other party gives the server ∘∘ points”. The use of minus points makes one's demand (how many priority points one wishes for the other party to provide) clear from the beginning, and is accordingly advantageous in that the number of times arbitration is performed to reach completion is expected to be low.

In this case, the “feasibility estimation module” in the online processing module 2-3 of a server in the autonomous individual server group 2 attempts to demand points equivalent to a value that is calculated by multiplying the time (minutes) by 50%, as first priority right points. Specifically, the “feasibility estimation module” attempts to demand 15 points, which are calculated by 30 minutes×50%, for September 21st (Mon) and September 25th (Fri) each.

There is also an option in which the “alternative proposal creation module” or the “individual KPI calculation module” cuts short the schedule for September 21st (Mon) and September 25th (Fri) by 30 minutes to demand no priority right points, or an option of entirely rejecting the schedule suggested by the schedule arbitration server 1.

In this case, the schedule arbitration server 1 may approve the initial maintenance schedule of the server in the autonomous individual server group 2 as initially demanded, but the server in the autonomous individual server group 2 is also saddled with a risk of being moved to a time slot far from its desired time slot when arbitration is unsuccessful and another server in the autonomous individual server group 2 has claimed the time slot. This can be avoided, depending on what policy is created for the server in the autonomous individual server group 2 by an operator.

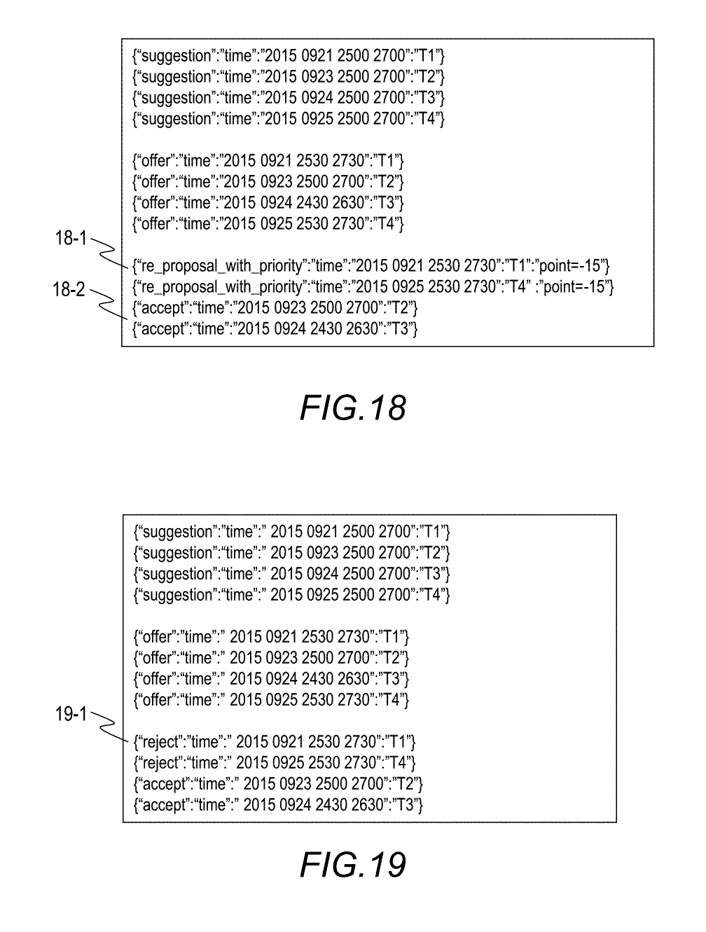

FIG. 18 is a diagram of the specifics of an assertion message in which an assertion message 18-1 about a re-proposal with minus priority right points (a re_suggestion_with_priority assertion message) and an acceptance message (accept assertion message) 18-2 are written together.

FIG. 19 is a diagram of an assertion message 19-1 about the rejection of an offer (a rejection assertion message). The rejection assertion message rejects a suggestion from the schedule arbitration server 1, and demands to be allowed to keep its initial suggestion without modifications.

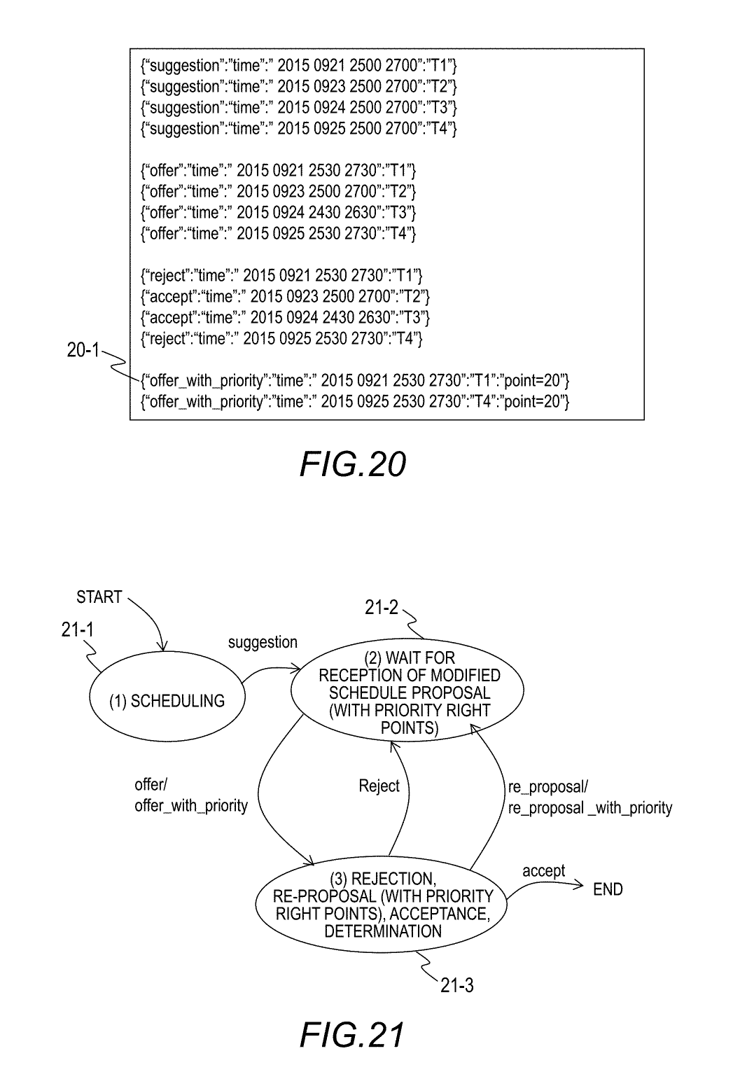

FIG. 20 is a diagram for illustrating an assertion message 20-1 in which, after receiving the rejection assertion message of FIG. 19 (or the re-proposal assertion message of FIG. 18) from an autonomous individual server, the schedule arbitration server 1 offers the same schedule to the autonomous individual server, with plus priority right points attached to the schedule (an offer_with_priority assertion message).

The assertion messages of FIG. 18 and FIG. 19 are created by an “autonomous individual assertion information creation module” in the online processing module 2-3 of the autonomous individual server of FIG. 6, and transferred from the “assertion message transmission module” of the communication processing module 2-2 to the schedule arbitration server 1 and all autonomous individual servers as a general rule.

An assertion message received by the “assertion message reception module” in the communication processing module 2-2 of FIG. 6 and an assertion message transmitted from the “assertion message transmission module” are transferred to the “assertion information recording module” and the “self-model tuning module”, which are included in the offline processing module 2-4, are compiled into a database by the “past history information module”, and are used as tuning parameters for a self-simulator by the “self-characteristics model module”.

The “past history information module”, the “self-characteristics model module”, and a “reference assertion message recording module” in the offline processing module 2-4 are referred to by the “feasibility estimation module” of the online processing module 2-3, to be used as reference information when an autonomous individual assertion message is created.

FIG. 21 is a diagram for illustrating transitions in the state of servers in the autonomous individual server group 2 from which assertion messages are sent.

First, servers in the autonomous individual server group 2 shift to (1) a schedule creation state 21-1 after being booted. The servers each use a suggestion assertion message to submit its desired schedule to the schedule arbitration server 1, which behaves as a cooperation field server. The servers then enter (2) a modified schedule suggestion (with priority right points) reception waiting state 21-2.

When an offer assertion message or an offer_with_priority assertion message is subsequently received from the schedule arbitration server 1, the servers shift to (3) a rejection, re-proposal (with priority right points), and acceptance determination state 21-3.

The servers each subsequently transfer a rejection assertion message, a re_suggestion assertion message, or a re_suggestion_with_priority assertion message to the schedule arbitration server 1, thereby shifting back to (2) the modified schedule suggestion (with priority right points) reception waiting state 21-2. On the other hand, the servers establish the specifics of the schedule by sending an acceptance assertion message to the schedule arbitration server 1, and ends the state 21-3.

The handling of priority right points is recorded by a priority right point recording module in the offline processing module 1-4 of the schedule arbitration server 1, or a priority right point recording module in the offline processing module 2-4 of each server in the autonomous individual server group 2.

A schedule that enables both the cooperation field server and the autonomous individual servers to pursue their benefits is completed by keep negotiating with the autonomous individual servers for arbitration through the intermediation of the schedule arbitration server 1.

### Second Embodiment

In a second embodiment of this invention, a case is described in which one of servers belonging to the autonomous individual server group 2 does not submit a schedule in a form intended by the schedule arbitration server 1, which behaves as a cooperation field server.

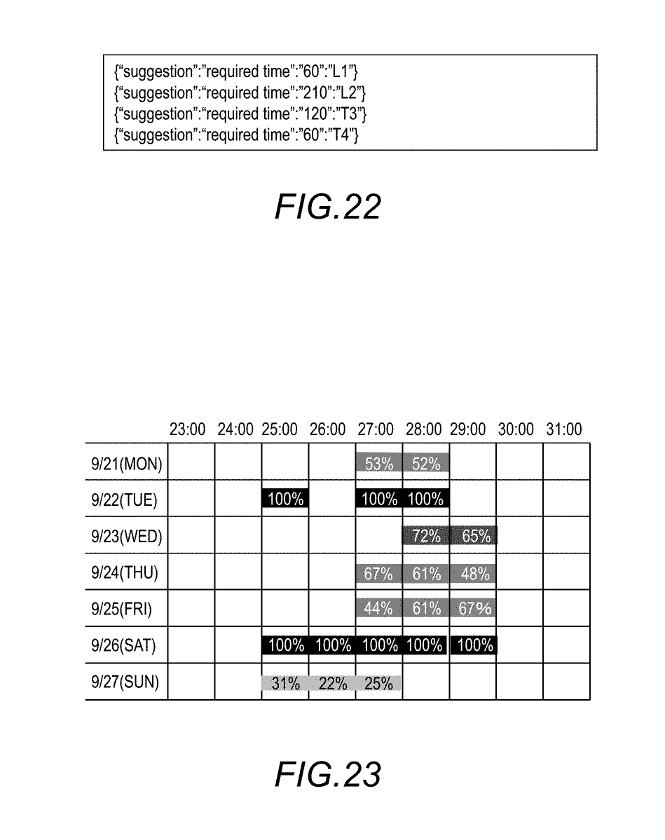

For example, a case is considered in which the light maintenance planning server 2-L transmits only maintenance sections and required times in a suggestion assertion message as in FIG. 22, instead of submitting a schedule as the one illustrated in FIG. 5-2. The individual KPI in this case is considered to be “100% accomplished” when the maintenance sections and the required times are fulfilled, irrespective of which time slots are allocated. In other words, the lack of a clear expression of intention in an initial maintenance message on the part of a server in the autonomous individual server group 2 equals to an expression of intention that the server accepts detrimental treatment relative to other servers in the autonomous individual server group 2.

In addition, a company running the light maintenance planning server 2-L has one regular full-day holiday a week, and maintenance tasks cannot be conducted in some time slots on some days of the week, which is not notified to other autonomous individual servers in the autonomous individual server group 2 because, for example, the pieces of information are considered here as equivalent to trade secrets to be kept from competitors.

The suggestion assertion message of the light maintenance planning server 2-L is received by the “assertion message reception module” in the communication processing module 1-2 of the schedule arbitration server 1 of FIG. 9, which behaves as a cooperation field server, and is transferred to the “assertion message confirmation module” of the online processing module 1-3 to be recognized as an incomplete schedule missing time point information, although the message contains time period information. Then, the suggestion assertion message is transferred to the “missing information estimation module”.

The “missing information estimation module” accesses the “past history information” for the light maintenance planning server 2-L in the offline processing module 1-4 to search past schedule information for a schedule closest to the incomplete initial schedule, and associates the found schedule with the current incomplete initial schedule. Specifically, the “missing information estimation module” searches for a past schedule in which maintenance tasks in the sections L1 to L4 are conducted once a week and the lengths of maintenance time are close to the required times in the current incomplete initial schedule.

When the “missing information estimation module” fails to find close enough information, an “autonomous individual characteristics model reference module” for the light maintenance planning server 2-L in the offline processing module 1-4 is accessed in order to extract, from past information, time slots in which a rejection assertion message and a re-suggestion assertion message tend to be issued, and an interim schedule, which avoids such time slots, is created.

FIG. 23 is a diagram for illustrating time slots in which a rejection assertion message and a re_suggestion message are likely to be issued. Each value written in FIG. 23 represents the ratio of the number of rejection assertion messages and re_suggestion assertion messages to the number of all assertion messages. An offer assertion message sent in a time slot in which the ratio has a large value is not likely to be received.

The created schedule is an interim schedule sent from the autonomous individual server handling light maintenance, and arbitration is subsequently performed by the method described in the first embodiment.

While the embodiments described above deal with events related to a maintenance schedule of an express highway, this invention is applicable to other systems as well.

For example, this invention can also be used as a system for arbitrating railroad maintenance schedules by changing the track maintenance planning server of FIG. 2 to a railroad track maintenance planning server, changing the light maintenance planning server to an overhead wire maintenance planning server, changing the traffic operation management server to a train operation planning server, and treating the interchanges N1 to N10 of FIG. 4 as railroad stations.

“Railroad track maintenance” means tasks of maintaining rails for trains. For example, the work of raising rails for trains, which keep sinking lower due to the weights of trains, with the use of dirt and gravel is one of the railroad track maintenance tasks.

“Overhead wire maintenance” means tasks of maintaining power lines that are strung overhead to supply electric power to trains. For example, the work of replacing a power line that is worn from friction with pantographs of trains and stringing a new power line is one of the overhead wire maintenance tasks.

“Power maintenance” means a repair or replacement of an electric device that is conducted for a stable supply of electric power to trains. “Train operation” means matters related to running trains. In the second embodiment, however, a power maintenance section and a train operation section are treated as a section in which electricity flows and a section in which a train is run, respectively.

### REFERENCE SIGNS LIST

Schedule arbitration server 1, network 3, track maintenance planning server 2-T, light maintenance planning server 2-L, power maintenance planning server 2-P, traffic operation management server 2-O, CPU 11-01, memory 11-02, communication NIC 11-03, hard disk drive 11-04, input/output controller 11-05, monitor controller 11-06, bus 11-07, operation processing module 2-1, communication processing module 2-2, online processing module 2-3, offline processing module 2-4, operation processing module 1-1, communication processing module 1-2, online processing module 1-3, offline processing module 1-4, offer assertion message 16-1, 16-2, re_suggestion_with_priority assertion message 18-1, accept assertion message 18-2, rejection assertion message 19-1, offer_with_priority assertion message 20-1, (1) schedule creation state 21-1, (2) modified schedule suggestion (with priority right points) reception waiting state 21-2, (3) rejection, re-proposal (with priority right points), and acceptance determination state 21-3

1. A schedule arbitration system, comprising:
a first server configured to send a first scheduling constraint, which is stored in advance, and first schedule information of a given period to a schedule arbitration server;
a second server configured to send a second scheduling constraint, which is stored in advance, and second schedule information of a given period to the schedule arbitration server; and
the schedule arbitration server comprising a control unit, which is configured to arbitrate a schedule of the first server and a schedule of the second server, and a storage unit,
wherein the storage unit of the schedule arbitration server is configured to store overall optimization constraint information, and
wherein the control unit of the schedule arbitration server comprises:
an obtaining module configured to obtain the first scheduling constraint and the first schedule information from the first server, and to obtain the second scheduling constraint and the second schedule information from the second server;
a discrepancy detection module configured to detect a discrepancy between the first schedule information and the second schedule information, based on the first scheduling constraint, the first schedule information, the second scheduling constraint, and the second schedule information, and on the overall optimization constraint information, which is stored in the storage unit;
a schedule recreation module configured to recreate a schedule when a discrepancy is detected, by creating third schedule information and fourth schedule information through modification of the first schedule information and the second schedule information;
a credit calculation module configured to calculate a first credit for the first server and a second credit for the second server, based on degrees of modification; and
a transmission module configured to send the third schedule information and the first credit to the first server, and configured to send the fourth schedule information and the second credit to the second server.

2. The schedule arbitration system according to claim 1,
wherein the first server is configured to execute a plan based on the third schedule information, and
wherein the second server is configured to execute a plan based on the fourth schedule information.

3. The schedule arbitration system according to claim 2,
wherein the first server and the second server are further configured to receive one of input of approval and input of rejection with respect to one of the third schedule information and the fourth schedule information, and the first server and the second server each comprise a transmission module configured to transmit a notification of one of the input of approval and the input of rejection to the schedule arbitration server,
wherein the schedule arbitration server is configured to send, when the input of approval is obtained, the third schedule information and the fourth schedule information to the first server and the second server, respectively, and
wherein the schedule arbitration server is configured to modify, when the input of rejection is obtained from one of the first server and the second server, at least one of the overall optimization constraint information, the third schedule information, or the fourth schedule information.

4. The schedule arbitration system according to claim 3, wherein, when credits are sent from at least one of the first server or the second server, priority is given to schedule information suggested by one of the first server and the second server that sends more credits than another one of the first server and the second server, and one of the schedule information of the another one of the first server and the second server and the overall optimization constraint information is modified again.

5. The schedule arbitration system according to claim 1, wherein the credit calculation module of the schedule arbitration server is configured to calculate, when at least one of the third schedule information or the fourth schedule information is modified in a manner that infringes on one of the first scheduling constraint and the second scheduling constraint, credits so that more credits are given to the at least one of the third schedule information or the fourth schedule information that infringes on the one of the first scheduling constraint and the second scheduling constraint than to one of the third schedule information and the fourth schedule information that stays within one of the first scheduling constraint and the second scheduling constraint.

6. The schedule arbitration system according to claim 1, wherein the credit calculation module of the schedule arbitration server is configured to calculate credits so that more credits are given to one of the first server and the second server that is higher in the degree of modification.

7. The schedule arbitration system according to claim 1,
wherein the storage unit of the schedule arbitration server is further configured to store past schedule modification information about modifications made on the first server and the second server, and
wherein the schedule recreation module of the schedule arbitration server is configured to recreate a schedule by creating third schedule information and fourth schedule information through modification of the first schedule information and the second schedule information, based on the past schedule modification information.
